(19) United States
(12) Patent Application Publication
(10) Pub. No.: US 2025/0201860 A1
(43) Pub. Date: Jun. 19, 2025

(54) DRY COATED ELECTRODES

(71) Applicant: FORD GLOBAL TECHNOLOGIES, LLC, Dearborn, MI (US)

(72) Inventors: Feng LI, Troy, MI (US); Chi PAIK, Grosse Ile, MI (US)

(21) Appl. No.: 18/539,173

(22) Filed: Dec. 13, 2023

(51) Int. Cl. H01M 4/62; C23C 24/06; H01M 4/04; H01M 4/134; H01M 4/1395; H01M 4/38

(52) U.S. Cl. CPC H01M 4/628; C23C 24/06; H01M 4/0404; H01M 4/0435; H01M 4/134; H01M 4/1395; H01M 4/386; H01M 4/622

(57) ABSTRACT

A lithium-ion battery electrode and a method for its fabrication are provided. The electrode comprises a current collector and a solvent-free electrode agglomeration of lithium organic compound, active material powder, and binder mechanically adhered to the current collector such that the electrode is resistant to solid electrolyte interphase formation on a surface of the electrode during cycling of the battery.

### TECHNICAL FIELD

This disclosure relates to an anode composition for lithium-ion battery cells.

### BACKGROUND

Lithium-ion batteries are widely used for portable electronic devices, electric vehicles, and renewable energy storage systems due to their high energy density and long cycle life. The performance of these batteries can depend on characteristics of their electrodes.

The application of lithium-ion battery technology in electric vehicles and energy storage systems is growing. Graphite remains the predominant choice for anode material in lithium-ion cells.

### SUMMARY

A battery comprises an electrode with a current collector and a solvent-free electrode agglomeration, having a lithium organic compound, active material powder, and binder. The solvent-free electrode agglomeration is mechanically adhered to the binder. The electrode is resistant to solid electrolyte interphase formation on a surface of the electrode during cycling of the battery. The lithium organic compound in the electrode may include dilithium, terephalate, or dilithium 2-aminoterephthalate. Additionally, the active material powder in the electrode may be silicon-based, while the binder may be selected from a range of materials including polymer-based, rubber-based, and inorganic binders.

A method for forming an electrode involves mixing a lithium organic compound with an active material powder and a binder to form a solvent-free electrode agglomeration, and applying the agglomeration to a current collector, so it mechanically adheres, forming an electrode that resists solid electrolyte interphase formation during the battery's cycling. The lithium organic compound in this method may be selected from dilithium, terephalate, or dilithium 2-aminoterephthalate. The application process may include calendering, and the active material powder is typically silicon-based. The method may also include steps for cutting and shaping the electrode.

Another method involves coating a current collector with the solvent-free electrode agglomeration comprising a lithium organic compound, active material powder, and binder. This creates an electrode that is resistant to solid electrolyte interphase formation during cycling. The lithium organic compound may be dilithium, terephalate, or dilithium 2-aminoterephthalate. The method may also involve calendering in the coating process. The active material powder used may be silicon-based. The method may further include cutting and shaping the electrode.

### BRIEF DESCRIPTION OF THE DRAWINGS

FIG. 1 is a schematic view of a battery cell according to one embodiment; and

FIG. 2. is a flowchart of an assembly process according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Developments towards high-energy-density alloying anode materials, such as silicon and silicon monoxide (SiOx), have been made and these materials are garnering increased interest in the development of lithium-ion batteries. Despite their potential, these anode materials, including graphite, silicon, and silicon monoxide, present a common challenge during battery operation. During the initial cycle, the electrolyte decomposes to form a solid electrolyte interphase (SEI) film on the anode surface. This formation of the SEI film stabilizes the electrolyte interface and prevents further decomposition, it may also lead to irreversible charge losses and a reduction in the available lithium within the battery system. This is particularly pronounced in systems utilizing these newer anode materials.

Another aspect of lithium-ion battery production that influences overall efficiency is the electrode coating process. Traditionally, wet coating techniques are employed in the electrode fabrication. However, this method is energy intensive. The wet coating process necessitates additional energy for drying and curing, which not only increases the energy footprint of the manufacturing process but also presents challenges in scaling up production.

A typical wet coating process can begin with the preparation of a slurry, a mixture containing active materials, binders, conductive additives, and solvents. The choice of active materials may significantly influences overall performance. Binders are used to maintain structural integrity, while conductive additives enhance electrical conductivity within the electrode.

Two common wet coating techniques are doctor-blading and slurry casting. In doctor-blading, the slurry is spread onto a current collector using a blade, resulting in a controlled, uniform layer. Slurry casting involves pouring the slurry onto the current collector and using a blade or rod to achieve the desired thickness. These methods may offer flexibility in adjusting coating parameters, allowing for customization based on specific battery requirements.

After coating, the wet film undergoes a drying and curing phase. This step removes solvents and binds the components together, forming a stable electrode structure.

A drying process may involve allowing the solvent to evaporate, leaving behind the solid components on the current collector. This evaporation step may be energy-intensive and contributes to overall production time. The choice of solvent plays a role; some solvents are more volatile than others, affecting the drying rate and energy requirements.

The control of drying conditions can be a factor in electrode formation. Non-uniform drying may lead to cracks, uneven thickness, or poor adhesion, potentially affecting the electrode's structural integrity and electrochemical performance. Achieving uniformity may be challenging in certain large-scale productions in which maintaining consistent drying conditions becomes more complex.

This disclosure relates to development of electrodes for lithium-ion batteries through solvent-free methods, specifically the direct incorporation of lithium organic compounds into the electrode fabrication process. Utilizing compounds such as dilithium terephalate or dilithium 2-aminoterephthalate, alongside active material powder and a binder, this approach inherently establishes a dry coating process due to the absence of solvents in the electrode mixture. The absence of solvents reduces the energy required for drying processes. The lithium organic compounds prevent the formation of a solid electrolyte interphase (SEI) during battery cycling. The lithium organic compounds stabilize the electrode-electrolyte interface, suppressing typical decomposition reactions that lead to SEI formation. The application of lithium organic compounds in the anode electrode coating process minimizes irreversible losses typically observed in battery operation. These losses, often occur due to reactions at the electrode-electrolyte interface and may be mitigated by the properties of the chosen lithium organic compounds. The electrode fabrication process involves a direct mixing and coating technique, where the lithium organic compounds, active material powder, and binder are combined in a homogeneous mixture. This mixture is then applied to the electrode surface in a dry state.

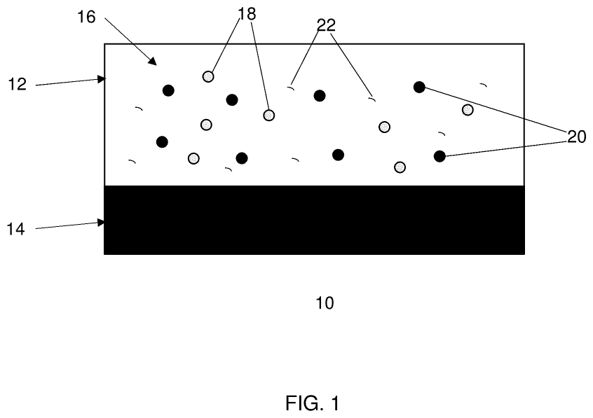

Referring now to FIG. 1 which illustrates a schematic view of a battery cell 10 having an electrode 12 and a current collector 14. The electrode 12 has a solvent-free electrode agglomeration 16. This solvent-free electrode agglomeration 16 comprises lithium organic compound 18, active material powder 20, and binder 22. The solvent-free electrode agglomeration 16 is mechanically adhered to the current collector 14 such that the electrode 12 is resistant to SEI formation on the surface of the electrode 14 during cycling of the battery 10. The lithium organic compound 18 may be dilithium, terphalate, or dilithium 2-aminoterephthalate. The lithium organic compound 18 negates the need for additional solvents in the electrode composition. The lithium organic compound 18 prevents the formation of a SEI on the electrode 12 during cycling due to the chemical as well as electrochemical stability of the lithium organic compound 18. The active material powder 20 may be silicon based such as silicon or silicon monoxide (SiOx). The binder 22 may be polymer-based, rubber based, or an inorganic binder.

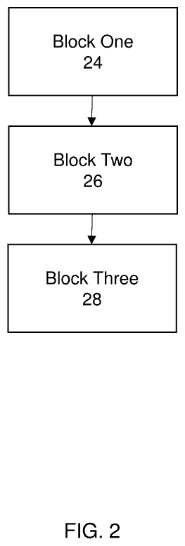

FIG. 2 is an illustration of a flowchart of an assembly process according to one embodiment. In Block One 24, a lithium organic compound is mixed with an active material powder and binder to form a solvent-free electrode agglomeration. In Block Two 26, the solvent-free electrode agglomeration is applied to a current collector such that the solvent-free electrode agglomeration mechanically adheres to the current collector to form an electrode resistant to SEI formation on a surface of the electrode during cycling. The lithium organic compound used may be selected from a group of compounds such as dilithium, terephalate, or dilithium 2-aminoterephthalate. In some configurations, Block Two 26 may also include calendering, which involves pressing the solvent-free electrode agglomeration onto the current collector to achieve some desired thickness and density. The active material powder may be silicon based such as silicon or silicon monoxide (SiOx). Other configurations may involve an optional processing step in Block Three 28. The processing in Block Three 28 may include cutting and shaping the electrode for dimensional conformance.

However, in another configuration Block One 24 may not be necessary and the method may only involve Block Two 26. In this configuration, Block Two 26 represents the step of coating a current collector with a solvent-free electrode agglomeration of lithium organic compound, active material powder, and binder to form an electrode resistant to SEI formation on a surface of the electrode. The lithium organic compound may also be selected from a group comprising dilithium, terephalate, or dilithium 2-aminoterephthalate. The coating step of Block Two 26 may also include calendering. The active material powder may similarly be silicon based such as silicon or silicon monoxide (SiOx). Optional further processing may still occur in Block Three 28. Which may include cutting and shaping the electrode for dimensional conformance.

The algorithms, methods, or processes disclosed or suggested herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery comprising:
an electrode including a current collector and a solvent-free electrode agglomeration of lithium organic compound, active material powder, and binder mechanically adhered thereto such that the electrode is resistant to solid electrolyte interphase formation on a surface thereof during cycling of the battery.

2. The battery of claim 1 wherein the lithium organic compound is dilithium.

3. The battery of claim 1 wherein the lithium organic compound is terephalate.

4. The battery of claim 1 wherein the lithium organic compound is dilithium 2-aminoterephthalate.

5. The battery of claim 1 wherein the active material powder is silicon-based.

6. The battery of claim 1 wherein the binder is selected from a group comprising polymer-based, rubber-based, or inorganic binders.

7. A method comprising:
mixing a lithium organic compound with an active material powder and binder to form a solvent-free electrode agglomeration; and
applying the solvent-free electrode agglomeration to a current collector such that the solvent-free electrode agglomeration mechanically adheres to the current collector to form an electrode resistant to solid electrolyte interphase formation on a surface thereof during cycling.

8. The method of claim 7 wherein the lithium organic compound is selected from a group comprising dilithium, terephalate, or dilithium 2-aminoterephthalate.

9. The method of claim 7 wherein the applying includes calendering.

10. The method of claim 7 wherein the active material powder is silicon-based.

11. The method of claim 7 further comprising cutting and shaping the electrode.

12. A method comprising:
coating a current collector with a solvent-free electrode agglomeration of lithium organic compound, active material powder, and binder to form an electrode resistant to solid electrolyte formation on a surface thereof during cycling.

13. The method of claim 12 wherein the lithium organic compound is selected from a group comprising dilithium, terephalate, or dilithium 2-aminoterephthalate.

14. The method of claim 12 wherein the coating includes calendering.

15. The method of claim 12 wherein the active material powder is silicon-based.

16. The method of claim 12 further comprising cutting the electrode.

17. The method of claim 12 further comprising shaping the electrode.
